(19) United States
(12) Patent Application Publication
(10) Pub. No.: US 2003/0069965 A1
(43) Pub. Date: Apr. 10, 2003

(54) Provisioning per cable modem

(75) Inventors: Donghai Ma, Acton, MA (US); Ajit Nair, Framingham, MA (US); Craig Boyle, Auburn, MA (US)

Correspondence Address: Fogg, Slifer & Polglaze, P.A., P.O. Box 581009, Minneapolis, MN, 55458-1009, US

(73) Assignee: ADC Telecommunications, Inc.

(21) Appl. No.: 09/972,379

(22) Filed: Oct. 5, 2001

(51) Int. Cl. H04N 7/16; H04N 7/173; G06F 15/173; G06F 15/16; G09G 5/00

(52) U.S. Cl. 709/225; 725/25; 709/229; 345/741

(57) ABSTRACT

A method and apparatus for provisioning on a per cable modem level includes associating any customer provided equipment behind a gateway cable modem to the same internet service provider as the cable modem.

The present invention relates generally to provisioning, and more specifically to provisioning in cable modems.

### BACKGROUND

A provisioning system, such as a provisioning server, is responsible for provisioning, or configuring, user access devices such as cable modems (CM), media termination adapters (MTA), and customer provided equipment (CPE). The provisioning system accomplishes this by generating configuration files from a configuration information database or the like, knowing the type of device that is requesting access. A provisioning system typically includes a dynamic host configuration protocol (DHCP) server having a processor, memory, and some type of mass storage such as a hard drive or the like, a trivial file transfer protocol (TFTP) server, a system log (SYSLOG) server, and a time of day server. The provisioning system may be a single computer functioning as all of the elements, or may be multiple computers connected together to function as a provisioning system.

Typically, in a cable modem configuration, such information as the media access control (MAC) address of the cable modem and other configuration information are required in order to configure the cable modem. The MAC address is a unique address identifier for devices such as cable modems, network interface cards, and the like.

Typical provisioning systems run on a chassis with various cards, requiring one cable modem termination system (CMTS) of a specific type that is usable with the system for interfacing between the chassis and cable modems. The cable modem is associated with an internet service provider (ISP) which allows access to the network through the cable modem as a gateway. Various user devices behind the cable modem are the true consumers of bandwidth and network resources that use the cable modem as a gateway.

There is a need in the art for provisioning on a per cable modem basis.

### SUMMARY

In one embodiment, a provisioning method includes associating a front end user access device to an internet service provider, and registering any secondary user access devices behind the front end user access device to the internet service provider to which the front end user access device is associated.

In another embodiment, a method for providing open access on a per device level includes assigning an internet protocol (IP) address to a user device upon a request for provisioning, and assigning an IP address within a same range as the IP address for the user device to each of a number of customer provided equipment devices behind the user access device.

In yet another embodiment, a method for provisioning open access on a per cable modem level includes receiving an access request from a cable modem for access to a network, and assigning an internet protocol (IP) address to the cable modem according to a subscription agreement with an internet service provider (ISP). Any customer provided equipment devices behind the cable modem are assigned separate IP addresses within a range of IP addresses belonging to the ISP.

In still another embodiment, a provisioning system includes a dynamic host configuration protocol (DHCP) server having a processor, a main memory, and a mass storage device, a trivial file transfer protocol server, and a network connection. The DHCP server has stored thereon a computer program for assigning an internet protocol (IP) address to a cable modem according to a subscription agreement with an internet service provider (ISP), and assigning separate IP addresses to each of at least one customer provided equipment devices associated with the cable modem. The separate IP address are within a range of IP addresses belonging to the ISP.

Other embodiments are described and claimed.

### BRIEF DESCRIPTION OF THE DRAWINGS

FIG. 1 is a flow chart diagram of a method according to one embodiment of the present invention;

FIG. 2 is a flow chart diagram of a method according to another embodiment of the present invention;

FIG. 3 is a flow chart diagram of a method according to yet another embodiment of the present invention;

FIG. 4 is a block diagram of a network according to one embodiment of the present invention; and

FIG. 5 is a block diagram of a computer on which embodiments of the present invention are practiced.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

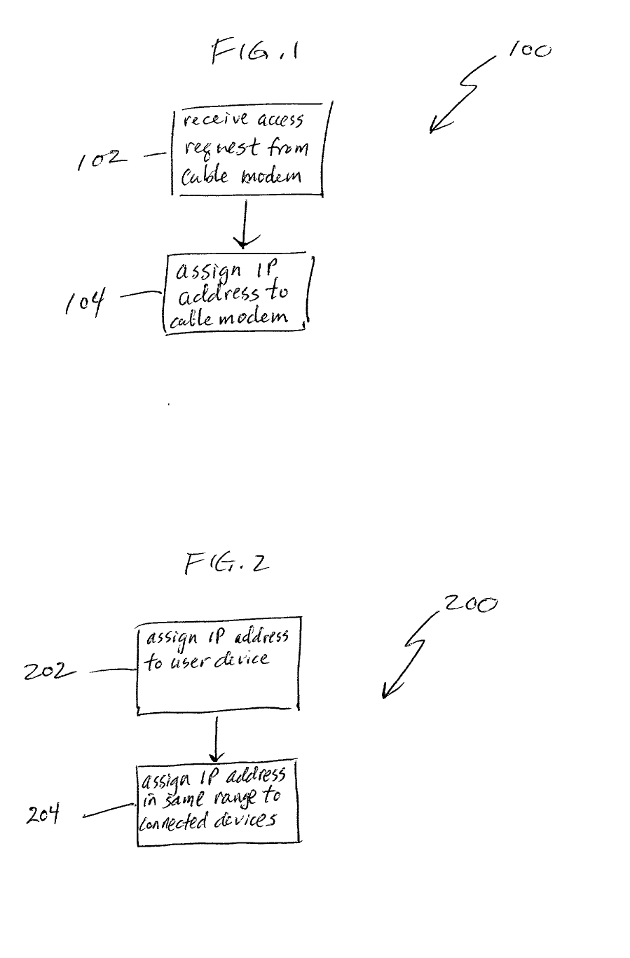

FIG. 1 is a flow chart diagram of a method 100 for providing open access on a per cable modem level, comprising receiving an access request from a cable modem for access to a network in block 102, and assigning an internet protocol (IP) address to the cable modem according to a subscription agreement with an internet service provider (ISP) in block 104. In one embodiment, separate IP addresses are assigned to each of at least one customer provided piece of equipment behind the cable modem. In this embodiment, the separate IP address or addresses assigned to the device or devices behind the cable modem are assigned from a range of IP addresses associated with the particular ISP that assigns the IP address to the cable modem. Therefore, all of the CPEs behind the cable modem are trackable by the ISP. This provisioning on a per cable modem basis allows an ISP to monitor and control the usage of its subscribers in a meaningful way.

It is the CPEs behind a user access device that that generate traffic for the ISP pipeline, and therefore use the ISP bandwidth and resources. The front end device, in one embodiment a cable modem, is only the gateway for other devices using the resources of the network. If the ISP assigns an IP address to the front end device, then it has no effective way to monitor usage and patterns of its users.

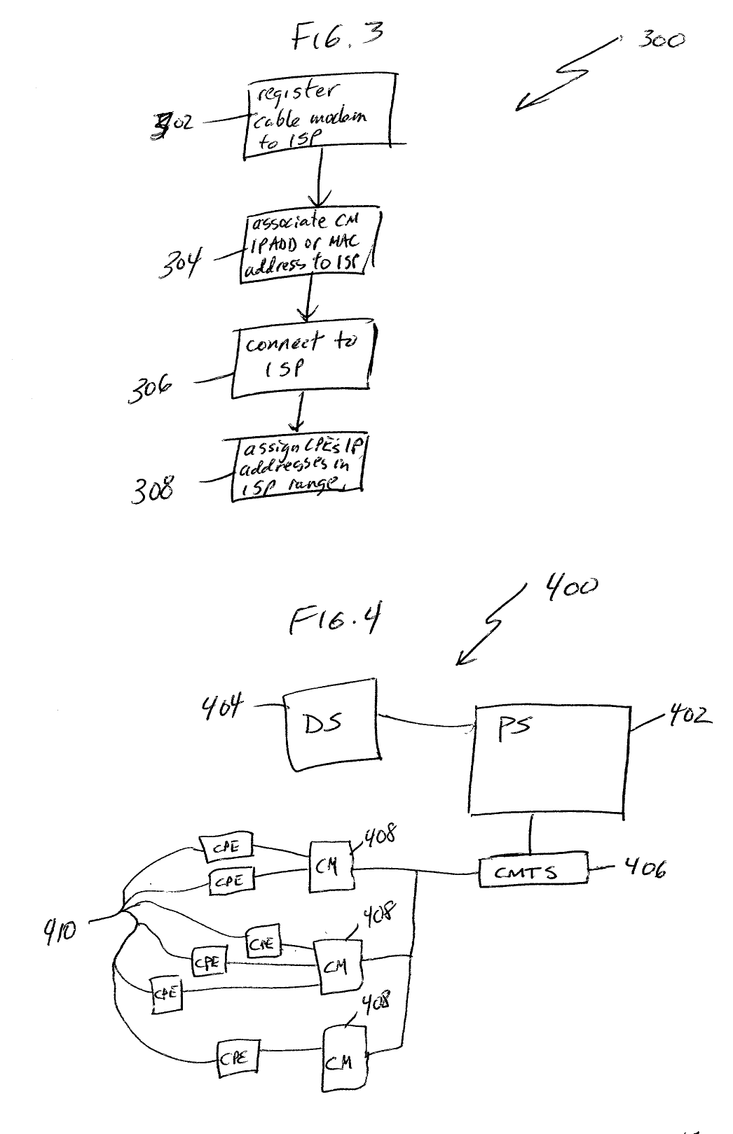

FIG. 2 is a flow chart diagram of another embodiment 200 of a method for providing open access on a per device level. Method 200 comprises assigning an internet protocol address to a user device upon a request for provisioning in block 202, and assigning an internet protocol address within the same range as the IP address for the user device to each of a plurality of CPEs behind the user access device in block 204. In one embodiment, the IP address assignment for the device is made through a typical provisioning scenario. Such provisioning is known, and will not be described further herein.

In provisioning, oftentimes the user access device is assigned an IP address in a default range for the provisioning server when it first makes contact with the provisioning server. In this embodiment, the initial IP address assigned to the device may not be in the range of IP addresses for the ultimate ISP the user chooses. However, the user device IP address is in some instances not changed, but simply associated with a particular ISP. This is because the front end user device is typically not the largest consumer of network resources, instead acting as a gateway to the actual consumer of resources, in this embodiment CPEs and the like connected behind the user access device, such as a cable television set top box, a personal computer, a handheld device, or the like.

In one embodiment, the IP address initially assigned to the user access device is changed once the user subscribes to an ISP. Each ISP typically has a number of subnets, and each subnet has a range of IP addresses with which it is associated. Once the user selects an ISP, in one embodiment, the IP address is changed so that the new IP address is within a range of IP addresses associated with the ISP. In another embodiment, the assigned IP address remains the same, but all CPEs behind the user device are assigned IP addresses within a range of IP addresses associated with the ISP the user has selected.

Open access on a per cable modem level is provided by the various embodiments of the present invention. A service provider owns or controls access to a network through subscriptions to the ISP and the provision of IP addresses to subscriber devices. A subscriber to a particular ISP in many instances uses multiple devices behind a single front end, or gateway, device, in one embodiment a cable modem. In one embodiment, as has been described, the cable modem is actually assigned an IP address by the provisioning server that provisions the CM. The IP address of the CM in one embodiment is tied to the provisioning server, but it is registered to the ISP. On a per device access level, all of the CPEs and other devices behind the CM are assigned IP addresses that are under the control of the subscribed to ISP.

FIG. 3 is a flow chart diagram of another method 300 for providing open access on a per cable modem level. Method 300 comprises registering or subscribing a cable modem user to an internet service provider in block 302, and associating any IP address already tied to the cable modem to the ISP in block 304. In block 306, the user connects to the ISP using the cable modem as a gateway for end user devices such as CPEs and the like behind the cable modem. Once the connection to the ISP is made, the CPEs behind the CM are assigned IP addresses within a range of IP addresses associated with the ISP in block 308. In one embodiment, the CM is tied to the ISP using its MAC address.

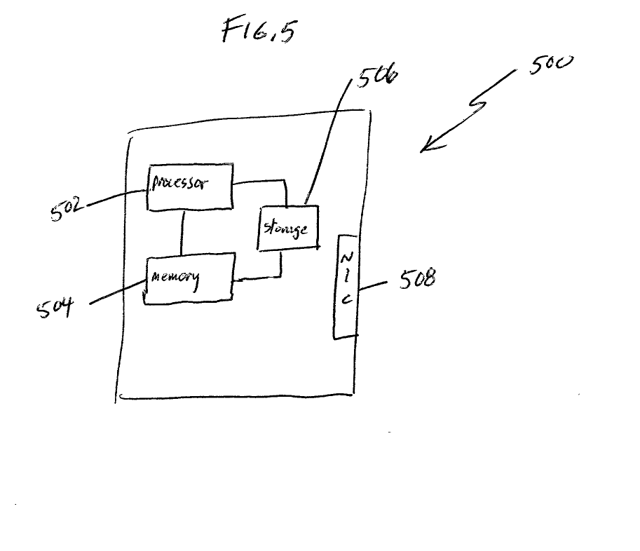

FIG. 4 shows a network 400 on which embodiments of the present invention are practiced. Network 400 comprises in one embodiment a provisioning server 402 connected to a directory server 404, having a network connection to a cable modem termination system (CMTS) 406 to which a number of user front end access devices 408 (in this embodiment cable modems) are connected. In turn, behind each of the cable modems 408, a number of CPEs 410 are connected. The CPEs use the cable modems as gateways to access the network 400. The directory server 404 in one embodiment stores provisioning information for cable modems and the like, and is accessed via lightweight directory access protocol (LDAP). The directory server may be local to the provisioning server, or remote therefrom.

FIG. 5 is a block diagram of a computer 500 such as a provisioning server on which embodiments of the present invention are practiced. Computer 500 has a central processing unit 502 connected to a main memory 504 and a mass storage device 506, as well as a network connection 508 such as a network interface card or the like.

The methods shown in FIGS. 1, 2, and 3 may be implemented in whole or in part in various embodiments in a machine readable medium comprising machine readable instructions for causing a computer such as is shown in FIGS. 4 and 5 to perform the methods. The computer programs run on the central processing unit 502 out of main memory 504, and may be transferred to main memory from permanent storage 506 via disk drive or CD-ROM drive when stored on removable media or via a network connection 508 or modem connection when stored outside of the computer 500, or via other types of computer or machine readable media from which it can be read and utilized.

Such machine readable media may include software modules and computer programs. The computer programs may comprise multiple modules or objects to perform the methods in FIGS. 1, 2, and 3 or the functions of various apparatuses of FIGS. 4 and 5. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A provisioning method, comprising:
associating a front end user access device to an internet service provider;
registering any secondary user access devices behind the front end user access device to the internet service provider to which the front end user access device is associated.

2. The provisioning method of claim 1, wherein registering secondary user access devices further comprises:
assigning IP addresses to any secondary user access devices within a range of IP addresses associated with the ISP to which the front end user device is associated.

3. A method for providing open access on a per device level, comprising:
assigning an internet protocol (IP) address to a user device upon a request for provisioning;
assigning an IP address within a same range as the IP address for the user device to each of a plurality of CPEs behind the user access device.

4. The method of claim 3, wherein assigning an IP address comprises:
determining an ISP of the device; and
assigning an IP address within an address range associated with the ISP.

5. The method of claim 4, wherein assigning IP address within the same range comprises:
determining the ISP to which the device is registered; and
assigning within a same range.

6. A method for provisioning open access on a per cable modem level, comprising:
receiving an access request from a cable modem for access to a network;
assigning an internet protocol (IP) address to the cable modem according to a subscription agreement with an internet service provider (ISP); and
assigning separate IP addresses to each of at least one customer provided equipment device, wherein the separate IP address are within a range of IP addresses belonging to the ISP.

7. The method of claim 6, wherein assigning an IP address to the cable modem further comprises associating a media access control (MAC) address of the cable modem to the ISP, and storing the MAC address at the ISP.

8. A method for provisioning open access on a per cable modem level, comprising:
registering a cable modem user to an internet service provider (ISP);
associating an IP address tied to the cable modem to the ISP;
connecting a user to the ISP using the cable modem; and
assigning IP addresses within a range of IP addresses associated with the ISP to any devices behind the cable modem.

9. The method of claim 8, wherein the cable modem is tied to the ISP using a media access control address.

10. A machine readable medium comprising machine readable instructions for causing a computer to perform a method, the method comprising:
assigning an internet protocol (IP) address to the cable modem according to a subscription agreement with an internet service provider (ISP); and
assigning separate IP addresses to each of at least one customer provided equipment device, wherein the separate IP address are within a range of IP addresses belonging to the ISP.

11. The machine readable medium of claim 10, wherein the cable modem is tied to the ISP using a media access control address.

12. A provisioning system, comprising:
a dynamic host configuration protocol (DHCP) server having a processor, a main memory, and a mass storage device;
a trivial file transfer protocol server; and
a network connection;
wherein the DHCP server has stored thereon for operation in main memory by the processor a machine readable medium comprising instructions for causing the DHCP server to execute a method comprising:
assigning an internet protocol (IP) address to a cable modem according to a subscription agreement with an internet service provider (ISP); and
assigning separate IP addresses to each of at least one customer provided equipment devices associated with the cable modem, wherein the separate IP address are within a range of IP addresses belonging to the ISP.
